(19) United States
(12) Patent Application Publication
(10) Pub. No.: US 2009/0119150 A1
(43) Pub. Date: May 7, 2009

(54) System and Method for End-Users to Customize Customer Service Business Solutions Offered as a Service Over a Network

(76) Inventor: Dimitri J. Stephanou, Tampa, FL (US)

Correspondence Address: The Marbury Law Group, PLLC, 11800 SUNRISE VALLEY DRIVE, SUITE 1000, RESTON, VA, 20191, US

(21) Appl. No.: 12/330,160

(22) Filed: Dec. 8, 2008

Related U.S. Application Data
(63) Continuation-in-part of application No. 10/710,644, filed on Jul. 27, 2004.

(51) Int. Cl. G06Q 50/00; G06F 17/30; G06Q 10/00

(52) U.S. Cl. 705/9; 707/104.1; 705/7; 705/11; 707/E17.044

(57) ABSTRACT

A system and method for end-users to customize customer service business solutions offered as a service over a network. The invention allows end-users to select and customize over a network a customer service business solution from a number of such business solutions offered by the vendor. It allows users to customize the selected business solution to their own business environment without the need for them to change any of the underlying programming code of the business solution. The system of the present invention is used for a variety of customer business solutions.

### CROSS REFERENCE TO RELATED APPLICATIONS

This application claims priority to, and is a continuation-in-part of, Ser. No. 10/710,644, filed Jul. 27, 2004, now pending, which is herein incorporated by reference in its entirety.

### BACKGROUND

Small to medium organizations are currently locked out from customer service enterprise software because of the relatively high cost to acquire and implement such software and their lack of resources to configure, customize and maintain such applications. Although some vendors are currently offering customer service enterprise software in a hosted or ASP model, such offerings have not adequately addressed the needs of small and medium organizations for low cost, user customizable, and industry specific solutions with quicker visible results. No vendor currently offers customers over the Internet a rapid and easy way to select, configure and customize to their own environments customer service enterprise software that cater to specific business needs.

Disclosed embodiments seek to cater to those needs by delivering web-based client configurable and customizable customer service enterprise business solutions in a service based model. The embodiments allow end users to customize to their own environment any of a number of web-based customer service business solutions in few simple steps, in a matter of few minutes. They thus makes it very easy to acquire, customize and run as a service customer service business applications “on the fly” with no need to have the internal IT resources to “program” those customizations or the equipment to run and support those business solutions. Furthermore, those customizations done by the end user without having to make changes to the code are stored in database files and are thus carried by future releases.

An exemplary embodiment is used as follows. A user within an organization, typically one with decision-making authority, identifies a business need within the organization. The user goes to a central location on the network where a number of software business solutions are offered as a service. The user then proceeds to provide information that allows the system to customize the business solution to cater to the organization's needs.

As a first step, the user enters information about the organization, selects the software business solution of interest, attaches the organization's logo, customizes a number of field labels and creates an administrator account.

Next, the user logs in as the administrator to continue with the configuration and customization of the business solution.

After logging-in as the administrator the user proceeds to add additional users to the system. Once adding users is done, the administrator has the option to have the system automatically email all users their login-credentials.

Next, the user proceeds to add service categories and service sub-categories to the business solution.

Next, the administrator proceeds to add experts and assign those experts to specific service categories and subcategories. The user also activates the experts and makes them available in the corresponding service categories and sub-categories.

In summary, a tool is disclosed that empowers users to rapidly customize business solutions and run them as a service over the Internet with no need to acquire any physical software and without any programming know-how.

### BRIEF SUMMARY

The disclosed embodiments provide a system and method for end-users to select, configure and customize customer service business solutions offered as a service over a network.

### BRIEF DESCRIPTION OF THE DRAWINGS

FIG. 1A illustrates the architecture of an embodiment.

FIG. 1B illustrates the overall sign-up, configuration and customization flow of an embodiment.

FIG. 1C illustrates the overall sign-in and use flow of the business solution by the client's customer after it has been configured and customized by the vendor's client.

FIG. 2 illustrates the login screen for users to access the business solutions. New users would use the “Click here to create a custom business solution!!” link to create and customize a new business solution for their organization.

FIG. 3 illustrates a screen consisting of a data entry sheet requesting a plurality of answers pertaining to creating and customizing the business solution. The user is asked to enter information about the client organization the user belongs to, select a business solution from a list of several solutions provided and customize the solution by attaching an organization logo and specifying some field labels. The user also creates an admin account that is needed to continue with the customization of the selected business solution.

FIG. 4 illustrates confirmation screen that summarizes the information that was entered in the previous step and allows the user to continue to the following step.

FIG. 5 illustrates a screen in which the user logs in into the system with the newly created admin credentials.

FIG. 6 illustrates a screen consisting of a segmented multi-step menu sheet that allows the admin to add or edit user information, service category information and expert service provider information pertaining to customizing the business solution.

FIG. 7 illustrates a screen consisting of a data entry sheet requesting a plurality of answers pertaining to adding users to the business solution. The sheet also provides a link that allows the newly added users IDs and passwords to be emailed to them.

FIG. 8 illustrates a screen consisting of the segmented multi-step menu sheet in FIG. 6 with a check mark next to the “Add Users” section representing that the step of adding users has been completed.

FIG. 9 illustrates a screen consisting of a data entry sheet requesting a plurality of answers pertaining to adding categories to the business solution.

FIG. 10 illustrates a screen consisting of a data entry sheet requesting a plurality of answers pertaining to adding sub-categories to the newly added category.

FIG. 11 illustrates a screen that confirms the category and corresponding sub-category added in the previous screens. The screen also provides a link to go to the category administration screen illustrated in FIG. 12.

FIG. 12 illustrates the category administration screen consisting of a data entry sheet requesting a plurality of answers pertaining to activating or deactivating categories and sub-categories, edit category and sub-category names, and add more sub-categories to a selected category. Users can access this screen from the link in FIG. 11 or by clicking on the “Edit Category” button on the segmented multi-step menu illustrated in FIG. 8.

FIG. 13 illustrates a screen consisting of the segmented multi-step menu sheet illustrated in FIG. 8 with a check mark next to the “Add Categories and Sub-Categories” section representing that the step of adding categories and sub-categories has been completed.

FIG. 14 illustrates a screen consisting of a data entry sheet requesting a plurality of answers pertaining to the first step of adding service experts to the business solutions.

FIG. 15 illustrates a plurality of categories that can be assigned to the expert.

FIG. 16 illustrates a plurality of sub-categories that can be assigned to the expert.

FIG. 17 illustrates a confirmation screen that shows that the service expert information has been successfully submitted. The screen also has a link to the “Expert Detail” screen illustrated in FIG. 18.

FIG. 18 illustrates a screen consisting of a data entry sheet requesting a plurality of answers pertaining to activating and making the expert available to accept service requests, changing the Expert's area of expertise, and changing other information pertinent to the expert.

FIG. 19 illustrates a screen that allows an expert to be activated in a certain sub-category or allows a sub-category to be deleted as an area of expertise for the expert. The screen also has a link to the screen that allows categories to be added as expertise areas for the expert illustrated in FIG. 15.

FIG. 20 illustrates a screen consisting of the segmented multi-step menu sheet illustrated in FIG. 13 now with a check mark next to the “Add Experts” section representing that the step of adding Experts has been completed.

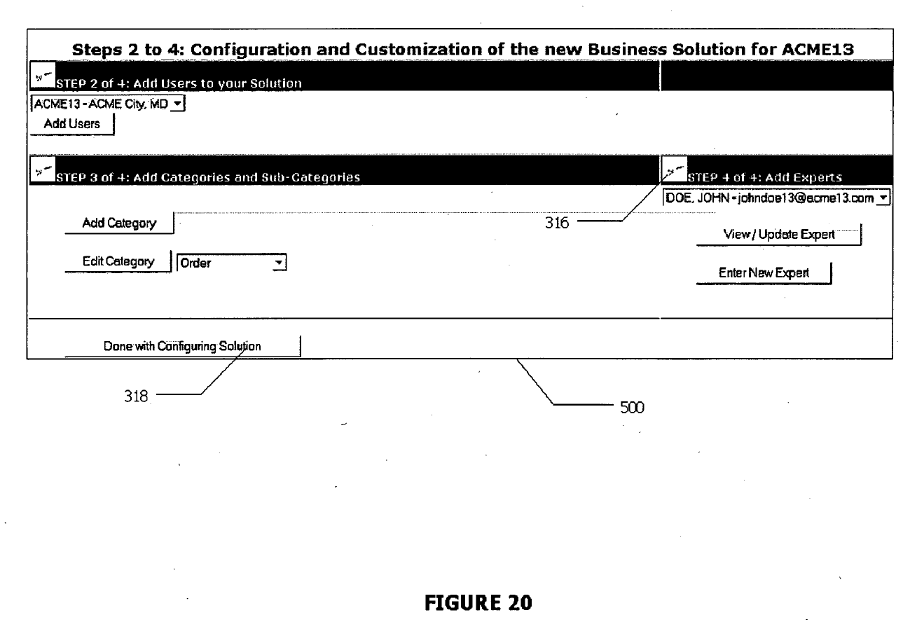

FIG. 21 illustrates the login screen for users to access the newly created and customized business solution.

FIG. 22 illustrates the system administration login screen for the system admin to make ongoing changes and administer the business solution.

FIG. 23 illustrates the system admin menu where the system admin makes changes and administer the business solution.

### DETAILED DESCRIPTION

The term “vendor” shall be taken to refer to any entity that owns and hosts a one or more network accessible business solutions on its servers connected to the network and offers the business solutions to clients.

The term “client” refers to any organization, private, government or public that participates in a transaction, communication or process, for the purpose of supporting its customers.

The term “customer” refers to any entity, human or automated, that participates in a transaction, communication or process for the purpose of communicating with the client.

The term “admin” or “administrator” refers to any entity, human or automated, that is affiliated with the client and participates in a transaction, communication or process through an embodiment to configure and customize a customer service business solution that can be used by the client to communicate and service its customers.

The term “business solution software” refers to any software application that is used by a client organization to solve challenges in their customer service workflow and in the process improve the quality and response-time of their customer service.

The term “expert” or “customer service representative” refers to any entity, human or automated, affiliated with the client that participates in a transaction, communication or process to provide customer service support in an expert capacity to the organization's customers.

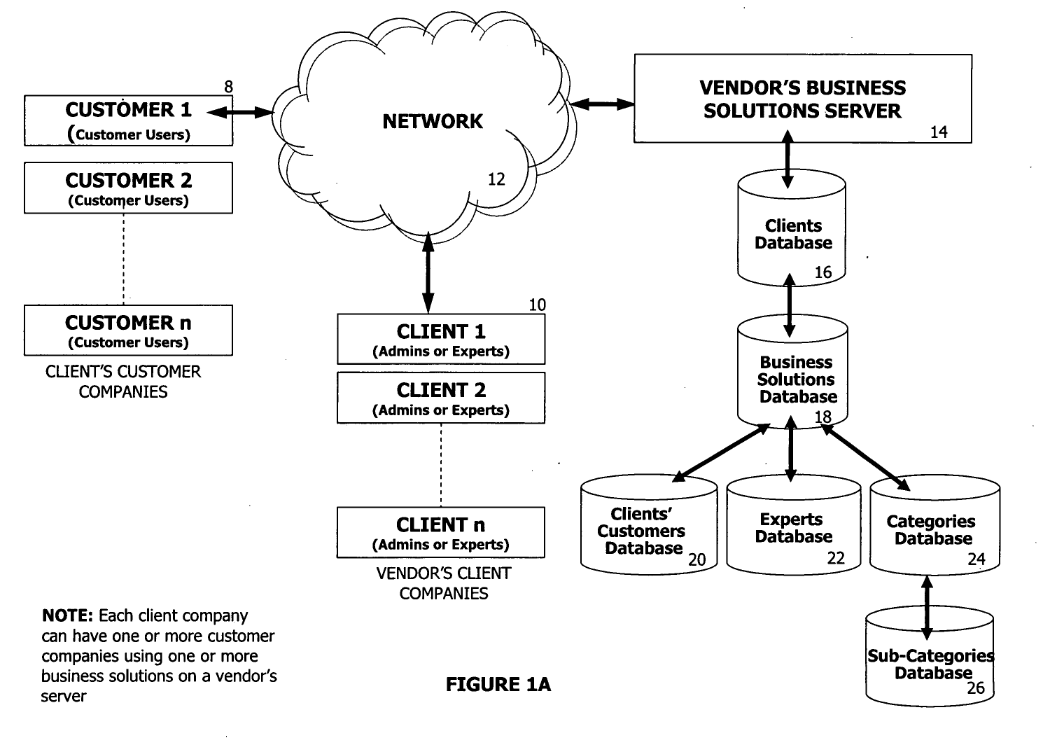

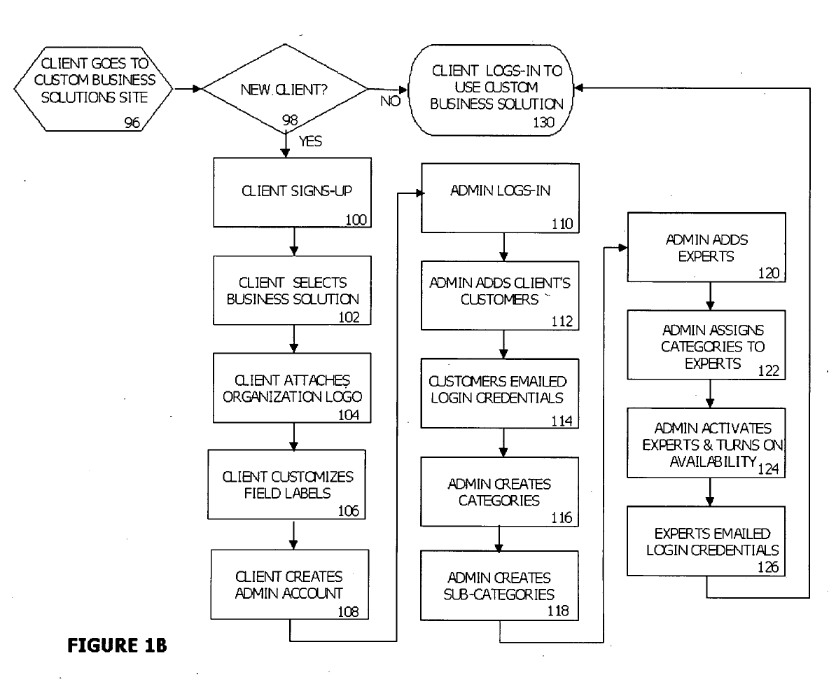

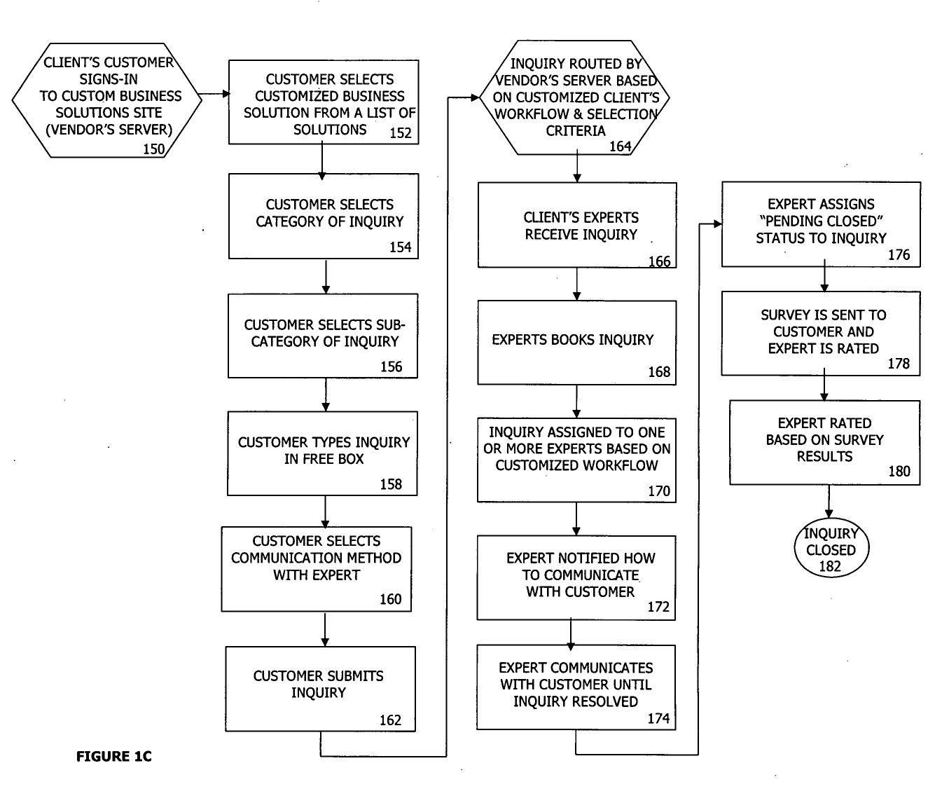

FIG. 1A illustrates the overall architecture of an embodiment and the relationship among the various users of the embodiment, namely the vendor who owns and hosts a number of business solutions on its servers 14 for client entities (also referred to as “client(s)”) 10, a number of vendor's client entities 10 who configure and customize one more of those business solutions of the vendor(s) for its customer entities (also referred to as “client's customers”) 8, and a number of customer entities (also referred to as “customers”) 8 who use one or more of those business solutions to communicate with the experts affiliated with the vendor's clients. The vendor server 14 is a networked computer with a processor for acting on software instructions and the clients 10 and customers 8 interact with the server 14 over network 12 using personal computers or workstations. A vendor's client, here shown simply as client 10 may wish to use a customized business solution to communicate and service its customers 8. Client 10 uses the network 12, preferably the Internet, although this is not meant as a limitation, to go to the business solutions server 14. The business solutions server 14 accesses a number of databases storing files on computer-readable media that pertain to customizing and later using those solutions. Those include, but are not limited to, a clients database 16 where pertinent data about the clients who use the business solutions to service their customers reside, a business solutions database 18 where pertinent data about the business solutions offered reside, a clients' customers database 20 where pertinent information about the client's customers reside, an expert database 22 where pertinent information about the client's customer service representatives reside, and a categories database 24 and sub-categories database 26 where pertinent information about the client's serviced categories and sub-categories reside. The server 14 further comprises instructions allowing the client 10 to customize the text fields used by the business solution to generate communication messages.

Referring now to FIG. 1B, the overall client sign-up, selection and customization of the customer service business solutions flow of an embodiment is illustrated. When a new client accesses the business solutions site 96, the client is directed to sign-up 100. An existing client can login and start using the customer service solution that has already been customized 130.

Once the client signs-up the organization, the user is asked to select a customer service business solution to be customized to cater to the organization's specific business needs 102.

The client then proceeds to customize the business solution's logo banner by attaching the organization's logo that would be displayed throughout the application when used 104.

After signing-up and customizing the logo banner and field labels, the client proceeds to create an administration (admin) account 108 and then use this admin account to login and continue with the customization of the business solution 110.

Upon login, the client admin will go through the remaining series of steps to complete the customization of the business solution. The admin will first add the customers (users) 112 who will be using the customer service solution to communicate with the client's representatives (experts). Once the customers are added, the admin instructs the server to send their login credentials through automated email messages 114.

The client admin next moves to the next step of creating the service categories 116 and service sub-categories 118. As an example, but without limitation, the client admin might create a category of “Clinical Trial 123” and 2 corresponding sub-categories of “Report Adverse Event” and “Contact CRA” for a clinical trials business solution that the client if customizing.

As a next step, the client admin adds the client's representatives (Experts) that will communicate and service the customers 120 and assigns the appropriate categories and sub-categories to each expert 122. For example, but without limitations, the client admin might add an expert “John Doe” and assign “Microsoft” and “Exchange” as the expert's category and sub-category areas of expertise respectively.

Next the client admin activates the experts and turns-on their availability if applicable 124. Finally the client admin emails the experts their login credentials 126 which they can use to login to the customized business solution 130.

Referring to FIG. 1C, an existing client's customer signs in to the vendor's business solutions server 150 to use a business solution that has already been customized by vendor's client as illustrated in FIG. 1B. Upon sign-in to the vendor's server that holds all data pertaining to vendor's various clients and their respective customers, the client's customer selects a customized business solution from a list of customized business solutions that the vendor's client has customized for its customer 152. The client's customer then chooses a category 154 and sub-category 156 for its inquiry, types the details of the inquiry in the free-text box 158 and selects the desired communication method to use with the expert 160. Upon clicking on the submit button, the inquiry goes to a number of client's experts 166. The notification of the experts is carried by the vendor's server by means of an automated workflow in the business solution that has been customized by vendor's client. This business workflow uses data stored in vendor's database that include, but is not limited to, real-time availability of client's experts, area of expertise broken down by category and sub-category, past performance of experts based on client's customer ratings, and maximum number of allowed open inquiries. This customized workflow also routes the inquiry to the expert 164 via a number of methods, including, but not limited to, email, paging, wireless or wired text, or voice messaging.

Once the appropriate number of client's experts receives an inquiry notification 166, the experts can choose to accept the inquiry 168 through a number of methods including but not limited to the Web, email, wireless or wired text, automated voice attendant, or do nothing. Once vendor's server receives the acceptance of an inquiry by a client's expert, it assigns the inquiry acceptance according to the workflow that the vendor's client has customized for its customer 170. This includes, but is not limited to, assigning the client's customer inquiry to the client's expert who was the first to respond as tracked by the vendor's server or assigning the inquiry to a number of those experts if such a request has been made by client's customer. The client's expert will receive a communication that includes any relevant information regarding the inquiry, including, but not limited to, the client's customer contact information. The client's expert will be instructed to respond to the client's customer and help address the nature of its inquiry within a time frame specified in the vendor's client customized workflow 172.

The client's expert and customer communicate through the vendor's customized business solution 174. All such communication goes through the vendor's server in order to track all statistics related to the inquiry that includes, but is not limited to, response time, quality of response and satisfaction level of customer. The vendor's server will also handle any alerts or escalation that the vendor's client will receive through the customized workflow of the business solution. Once the expert has resolved the customer's inquiry he changes the status of the inquiry to “pending closed” 176. At that point, the vendor's customized business solution sends a survey to the customer to rate the client's expert 178. The customized business solution then translates the survey results into performance metrics or factors s that the system uses in assigning future inquiries to the expert 180 and the inquiry is closed 182.

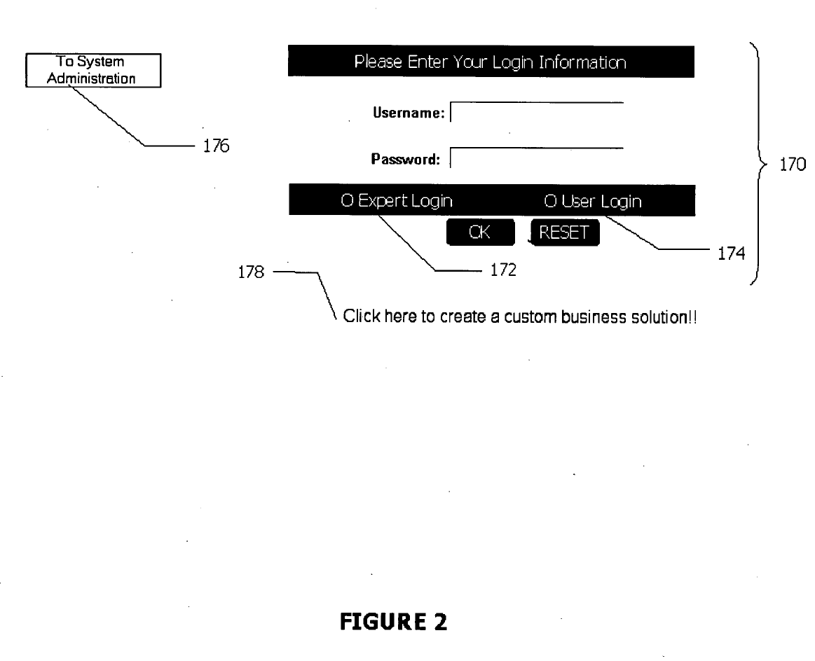

Referring now to FIG. 2 the main login screen is illustrated. For new clients, a link 178 below the login form 170 allows them to navigate to the various steps of an embodiment where they can configure and customize the customer service solution that caters to their specific business environment. Existing experts 172 and their customers (users) 174 would use the login form 170 to access the customized solution and the client administrator would use the “To System Administration” button 176 to access the administration functions of the business solution.

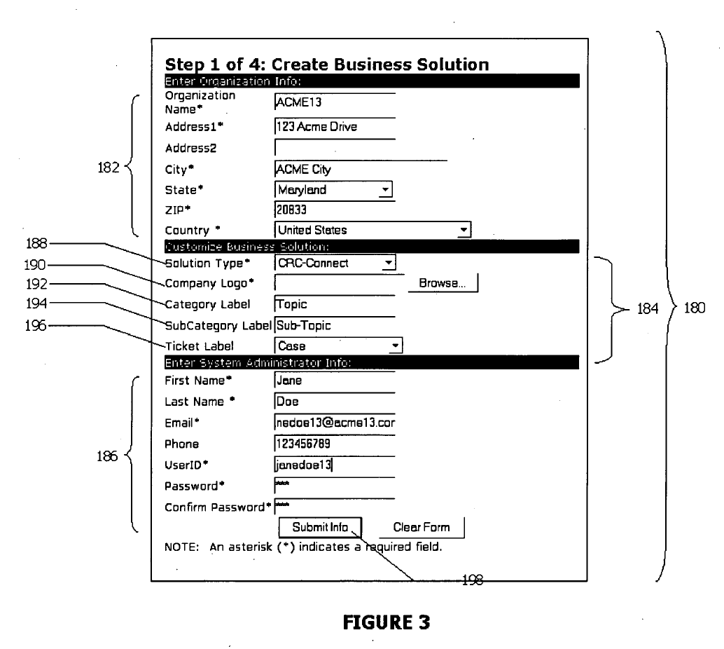

In FIG. 3 the new client sign up data entry sheet (form) 180 of an embodiment is illustrated. The sign-up form 180 consists of, but is not limited to, 3 sections. The first section 182 consists of information relevant to the client organization. As an example and without limitations, the organization info section 182 includes data entry information for the name and complete address of the client organization.

The second section 184 of sign up form 180 consists of information relevant to the top-level selection and customization of the customer service business solution of interest. In this section the client selects form a drop-down menu a business solution that caters to its specific customer service needs 188. As examples and without limitation such customer service solutions include a helpdesk solution, a generic customer service solution, a solution catered to the medical community, a solution catered to supporting clinical trials, a solution catered to support the linguistic community and other customer service applications that have been made available as client customizable solutions through various embodiments.

In section 184, the client can also customize the business solution's logo banner by attaching the organization's logo 190 that would be displayed throughout the customer service application. Other customizations possible in this section include, but are not limited to, customizing the field labels of the category 192, sub-category 194, and ticket 196 fields that are used in the customer service applications. As an example but without limitation, the client might name the label for a ticket 196 that is opened by a user when communicating with a customer service representative a “Ticket”, a “Case”, an “Incident”, an “Inquiry”, or any other term that the client likes to use in the customized service application. Similarly the client can customize the labels of the category field 192 and of the sub-category field 194 to cater to the business solution that is being customized and to the organization's preferences. As examples but without limitation, for a medical customer service solution, the client might name the labels of the category and sub-category data fields as “Doctor” and “Question Type” respectively or for a linguistic service solution “Language” and “Dialect” respectively.

In the third section 186 of data entry sheet 180, the client creates an Administrator (admin) account that will be used to continue with the configuration and customization of the customer service business solution. As examples but without limitation, information entered to create the admin account includes the name, email address, phone number, userID and password.

When all 3 sections in data entry sheet 180 are completed, the client submits the information entered into the corresponding database tables by clicking in the submit info button 198. Upon submitting the information in form 180, a new customized business solution is created in the business solutions database. A new client is also created in the clients' database and exclusive ownership of this new customized business solution is given to the client. From here on, any additional customizations or configurations made to this client's business solution by the client's admin will be only reflected in this particular client's solution and not in any other client's solution.

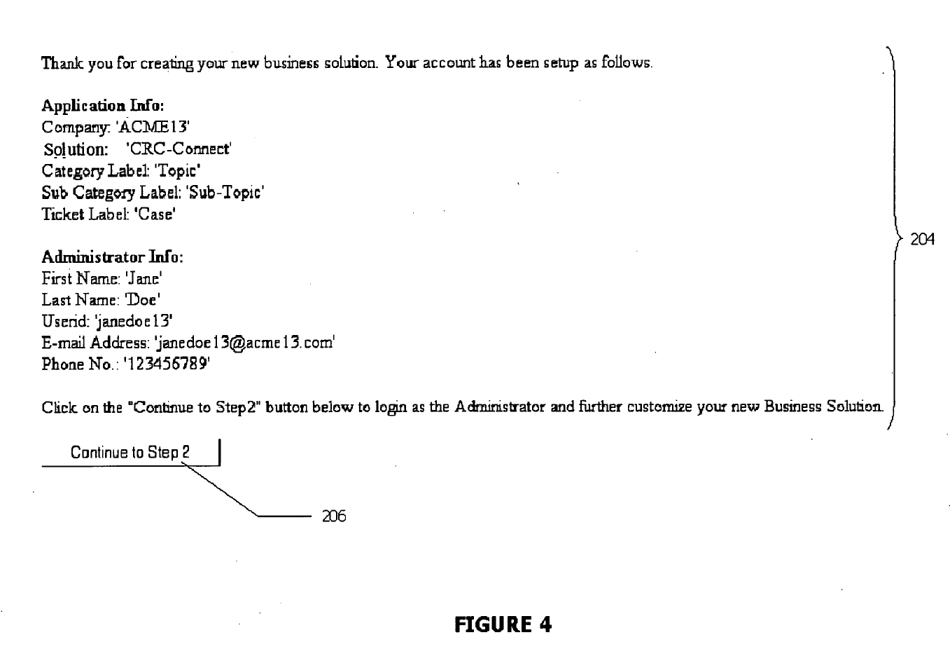

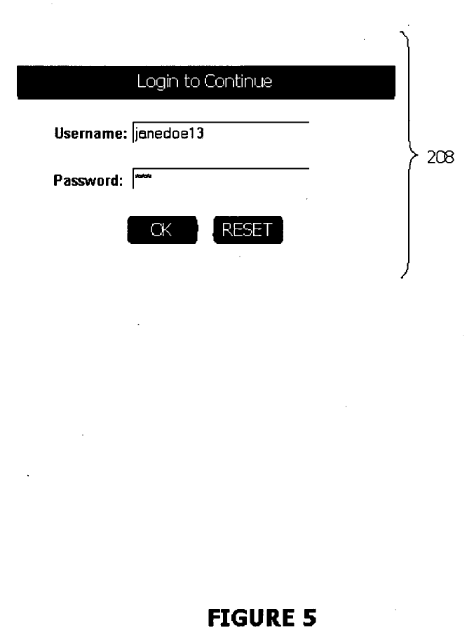

In FIG. 4 a summary 204 of the newly created custom business solution is illustrated. By clicking on the continue button 206, the client navigates through the other customization steps of an embodiment which require the client to login with the administrator account created earlier 186. FIG. 5 illustrates the administrator login form 208 where the client enters the userID and password of the administrator account and clicks the OK button to proceed.

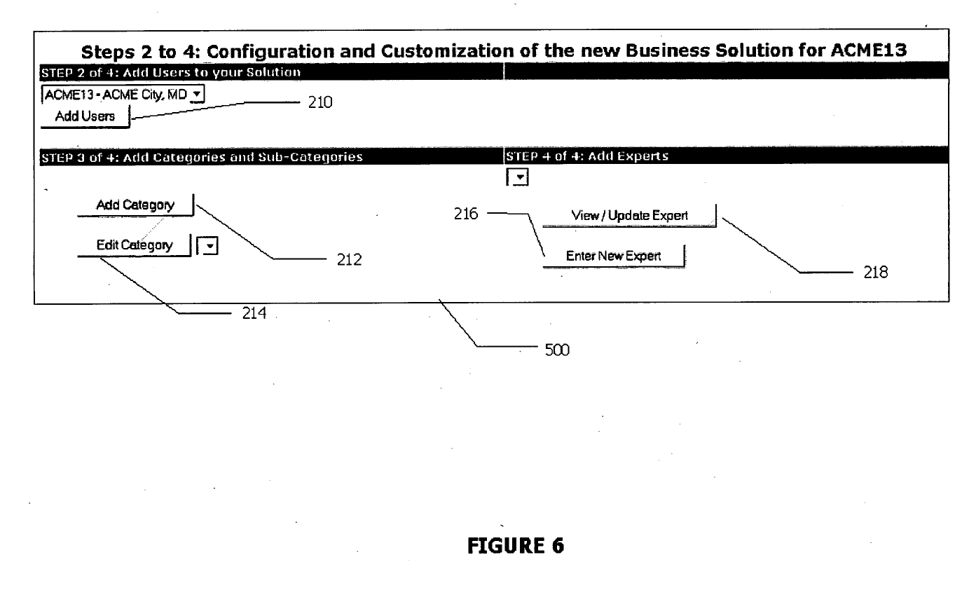

In FIG. 6 a screen of additional customization steps is illustrated. As an example and without limitation, FIG. 6 shows a dashboard with 3 main sections of additional customizations 500. Those sections include one for the client to add/modify customers (users) 210, one for the client to add 212 and modify 214 categories and subcategories for the client customers to use when communicating with the client's customer representatives and a section for adding 216 and modifying 218 customer representatives (experts).

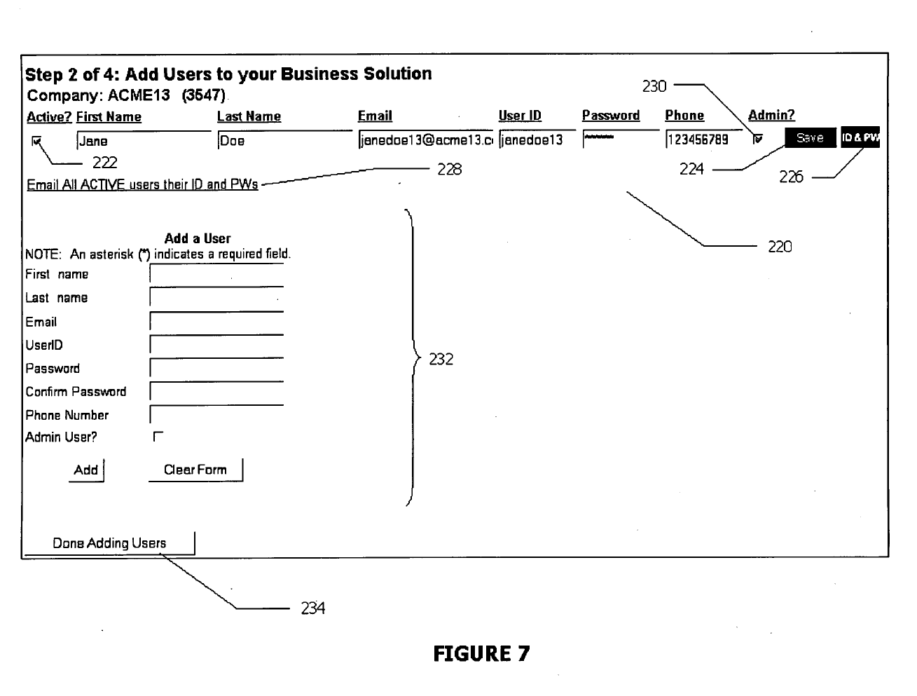

In FIG. 7 a two-part data entry sheet for adding/modifying customers (users) is illustrated. In the top part of the sheet 220, customers who already have been added as users of the customized business solution are listed. In addition to listing the customers, this section of the sheet allows the client admin to make any necessary updates to the customer's information and saving the changes by clicking on the Save button next to each customer record 224. The client can also activate or de-activating the user by clicking on the “Active” check box 222. The client can also email the userID and password of a customer whose login credentials have been changed by clicking on the “ID & PW” button 226 next to that record. When the credentials of all customers who have been added to the system need to be emailed to the corresponding users, the client can click on the “Email All ACTIVE users the ID and PWs” hyper link 228. The system also provides an option to allow the client to give limited admin user privileges to selected customers by clicking on the Admin check box 230.

The bottom part 232 of the data entry sheet in FIG. 7 illustrates how customer users are added. As the users are added using this form 232, the top part of the sheet 220 displays the new records. The “Done Adding Users” button allows the client to go back to the customizations dashboard 500.

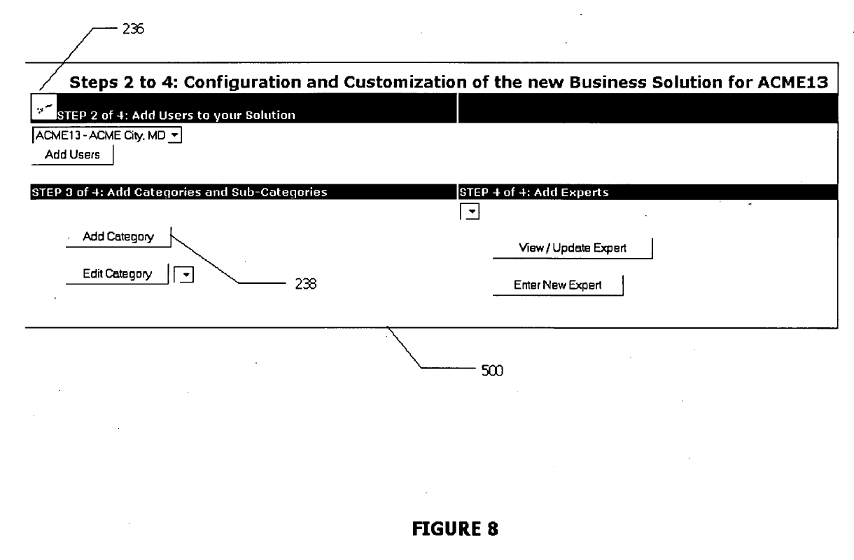

FIG. 8 illustrates the customization dashboard 500 with a check mark 236 next to the “Add Users to your Solution” section thus showing that this customization section has been completed. The client can thus now move to the next step of the customization namely adding categories by clicking on the “Add Category” button 238.

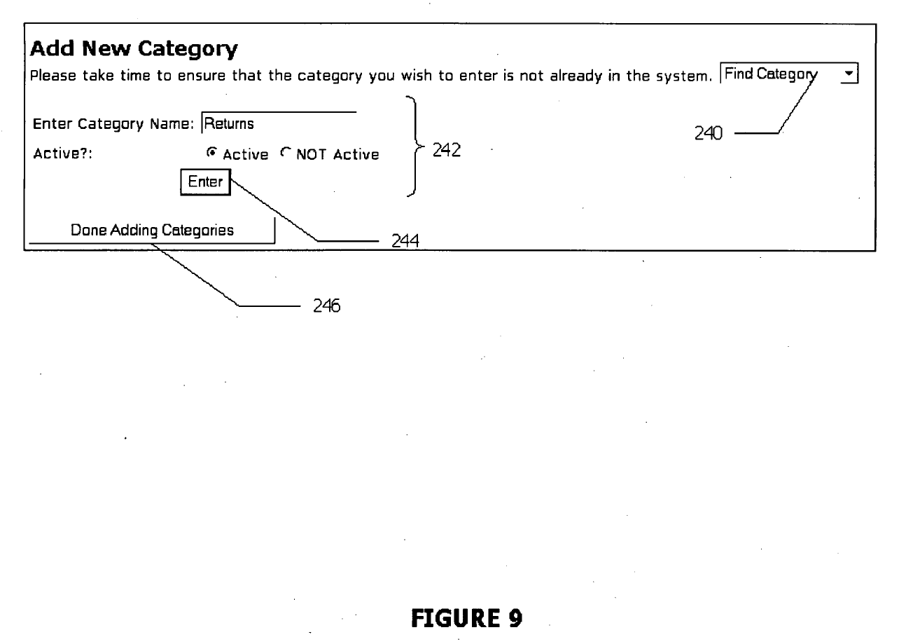

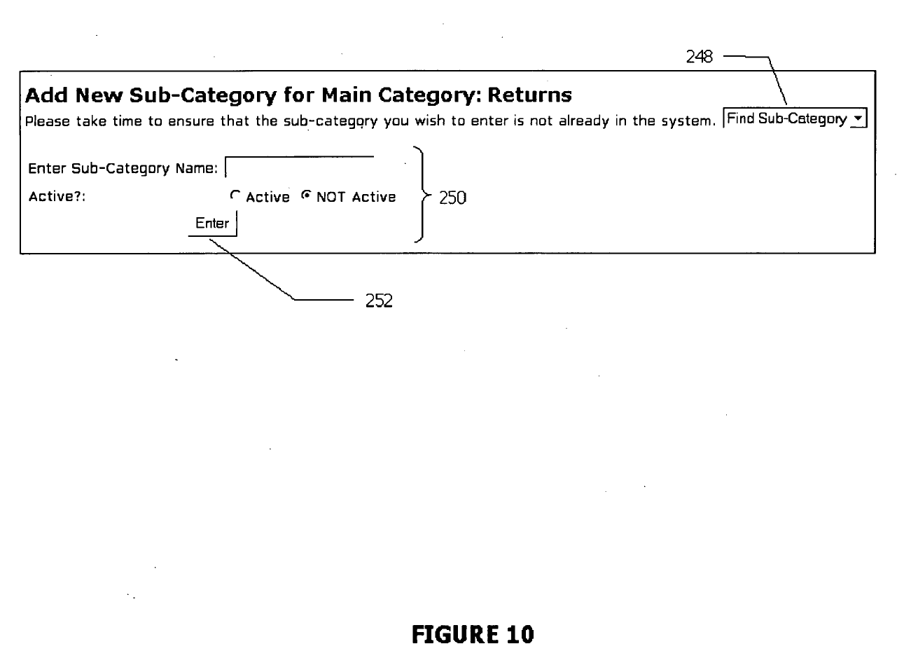

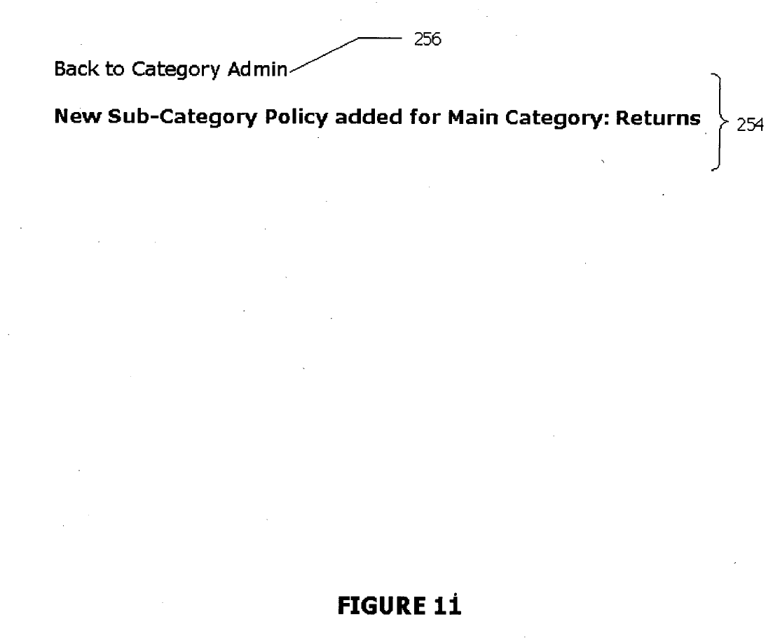

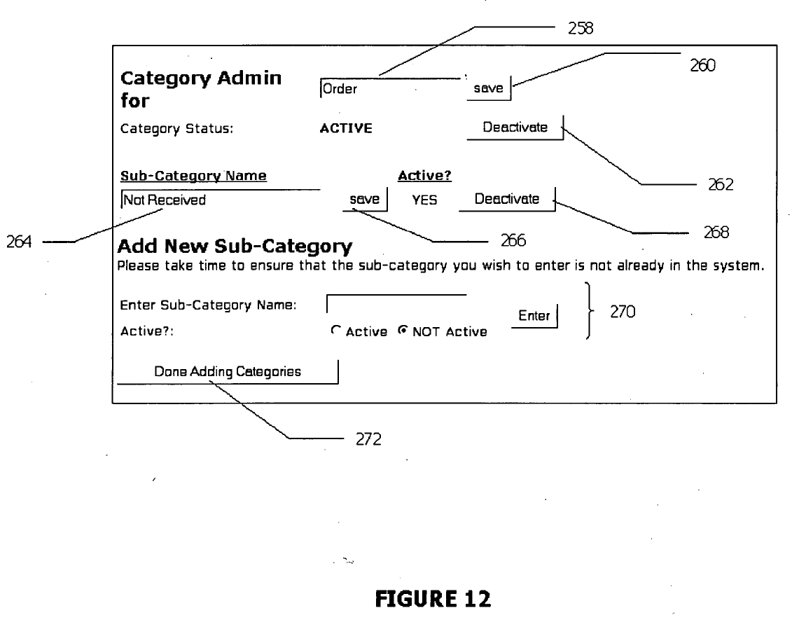

In FIG. 9 the screen to add categories to customer service business solution is illustrated. After checking that the new category to be added is not already in the system by looking in the drop-down list 240, the client uses form 242 to add the new category and make it active. After adding each new category the client clicks on the “Enter” button 244 to add the category in the categories database and go to the sub-category screen to add the corresponding sub-categories for each newly added category as illustrated in FIG. 10. When the first sub-category is added to the sub-categories database, a confirmation screen, as illustrated in FIG. 11, with summary info 254 about the category and sub-category just added is shown. The client goes to the category admin screen to add more subcategories or edit category/sub-category by clicking on “Back to Category Admin” link 256 in FIG. 11. In FIG. 12 the Category Admin screen is illustrated. In this screen, the client can edit a category 258 or a subcategory 264, and save those changes by clicking on the “save” buttons 260 or 266 respectively. The “Deactivate” buttons 262 and 268 allow the client to deactivate a category or sub-category respectively. Additional subcategories can be added in 270.

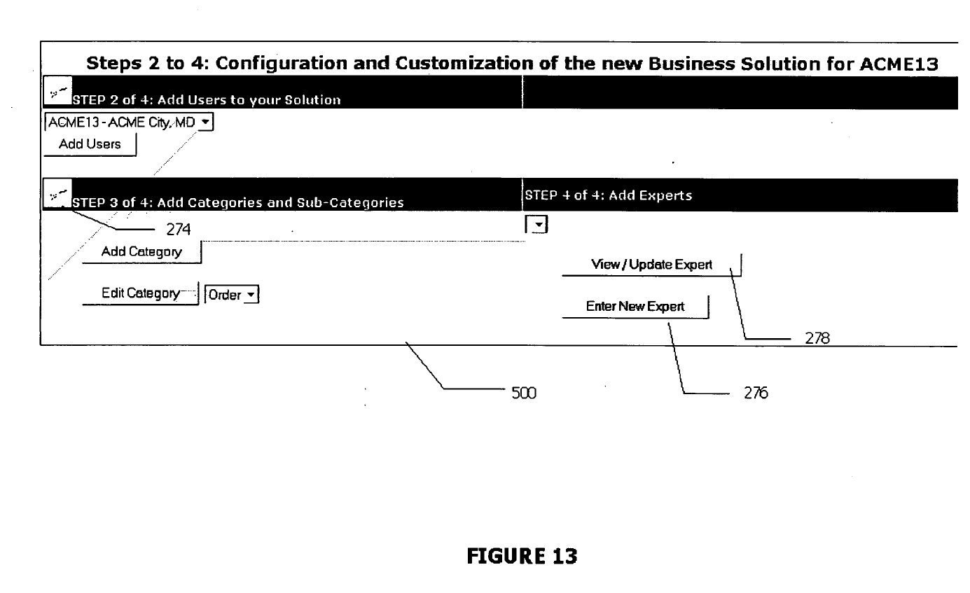

Once done adding categories, the client clicks on the “Done adding Categories” buttons 246 or 272 in FIG. 9 or FIG. 12 respectively and goes back to the customizations dashboard 500 with a check mark 274 next to the “Add Categories and Sub-Categories” section thus showing that this customization section has been completed as illustrated in FIG. 13. The client next can proceed by adding new client service representatives (experts) to the business solution by clicking on the “Enter New Expert” button 276.

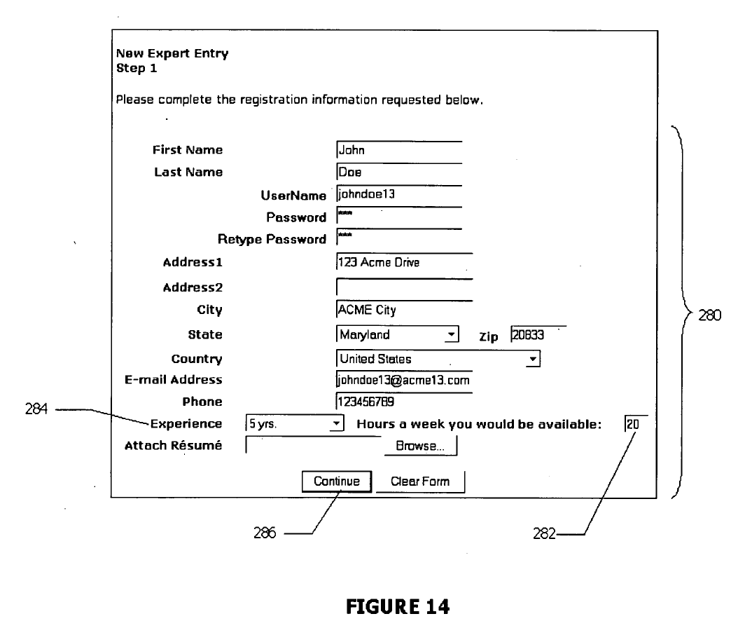

FIG. 14 to FIG. 19 illustrate the steps needed to add experts to the customer service business solution and assigning categories and sub-categories as areas of expertise to those experts.

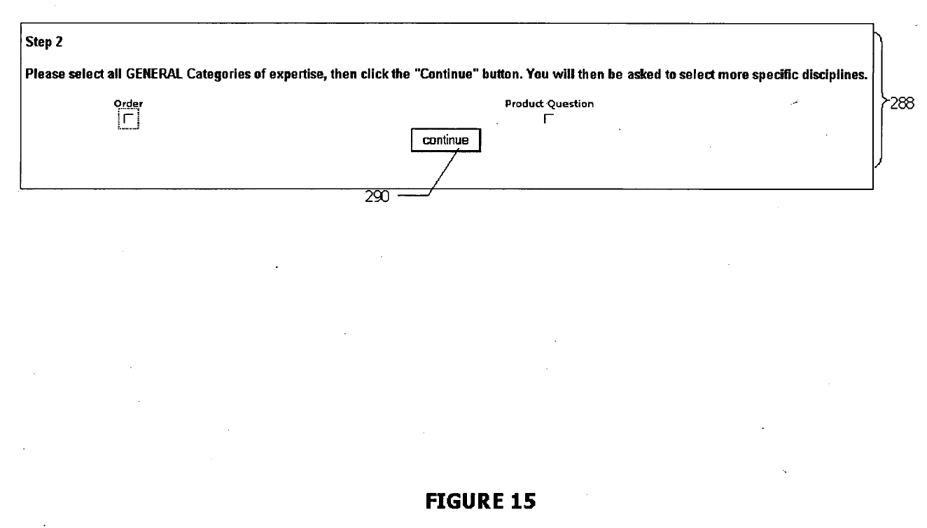

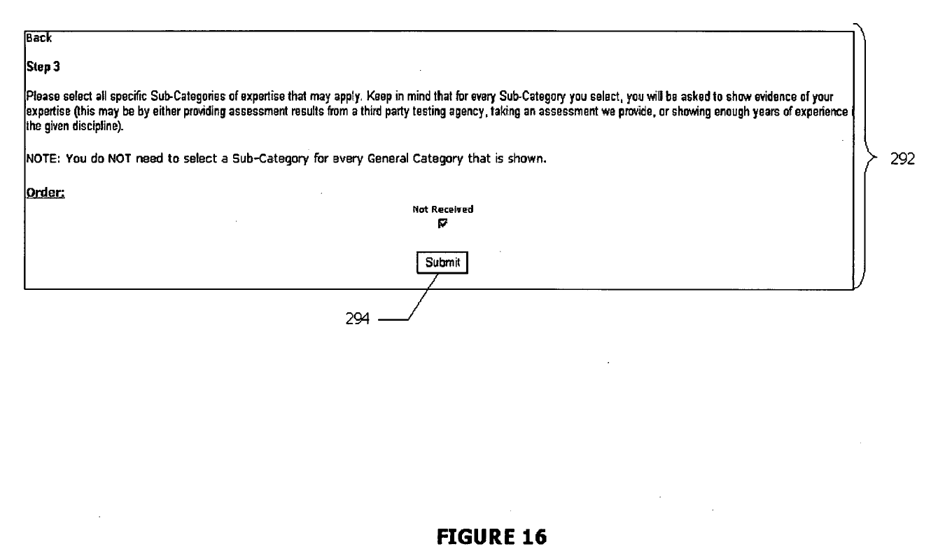

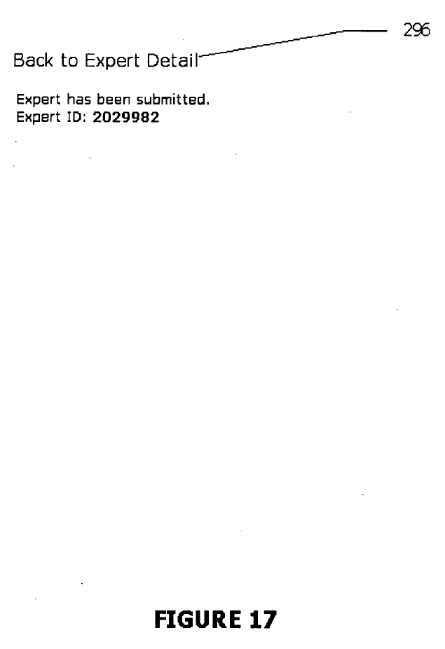

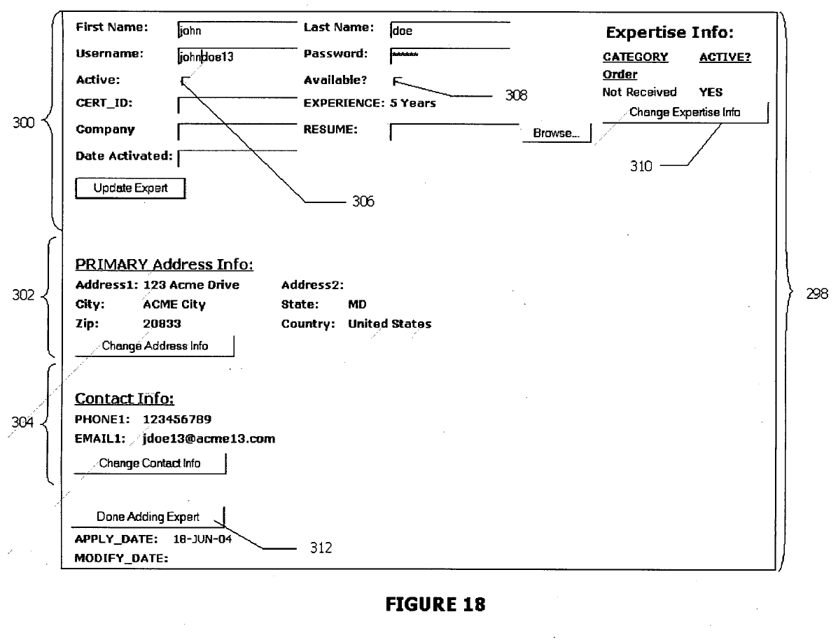

In FIG. 14 a data entry sheet for signing up 280 the client service representative (expert) is illustrated. As examples and without limitation, the data requested may include the name, address, contact information, userID, password, availability level, years of experience and resume of the expert being added to the solution. The availability level or number of hours per week the expert is available 282 and the experience level 284 are some of the factors, but not limited to, used by the system to assign priority and escalation levels for tickets being opened by customers. When the sheet 280 is filled, the client clicks on the “Continue” button 286 and navigates to the data entry sheet 288 illustrated in FIG. 15. The data entry sheet 288 provides the client with the list of categories supported by the client service solution. The client may thus assign categories that can be supported by the expert by checking the appropriate boxes next to those categories. When done with the categories assignment, the client click on the “Continue” button 290 and is taken to the subcategories assignment data entry sheet 292 illustrated in FIG. 16. When done with assigning the sub-categories the client clicks on the “Submit” button 294. FIG. 17 illustrates a screen that confirms that the new expert has been added. By clicking on the “Back to Expert Detail” link 296, the client is taken to data entry sheet 298 illustrated in FIG. 18.

In FIG. 18 a data entry sheet 298 for modifying client service representative (expert) detail information is illustrated. This sheet can be accessed through either the main customization dashboard 500 or through the “Back to Expert Detail” link 296.

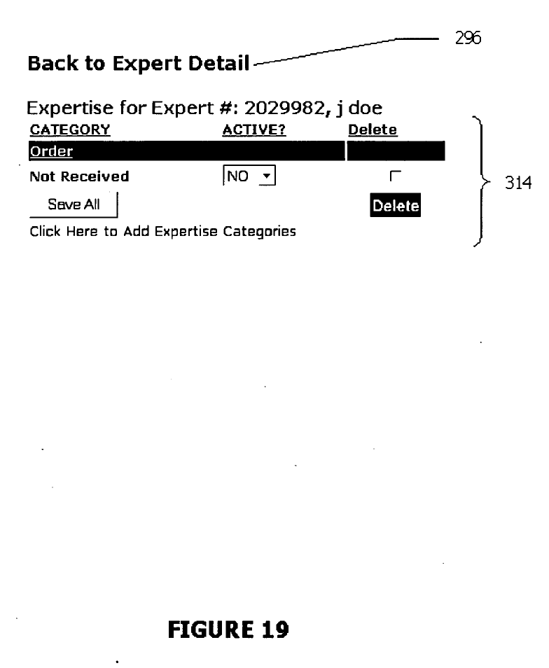

Data entry sheet 298 consists of 3 sections relevant to the expert information. Section 300 consists of general information for the expert and 2 check boxes that allow the client to activate the expert 306 and turn on the expert's availability 308 to take inquiries from customers. In addition, in this section, the client can zoom in on the areas of expertise that the expert has been assigned to by clicking on the “Change Expertise Info” button 310. When button 310 is clicked on, the client is taken to data entry sheet 314 where the client may activate, delete or add areas of expertise (assigned categories) to the expert as illustrated in FIG. 19. Sections 302 and 304 allow the client to change the address and contact information for the expert respectively. When the client clicks on the “Done Adding Expert” button 312, the client is taken back to customization dashboard 500 where now a check box 316 is shown next to the “Add Experts” section.

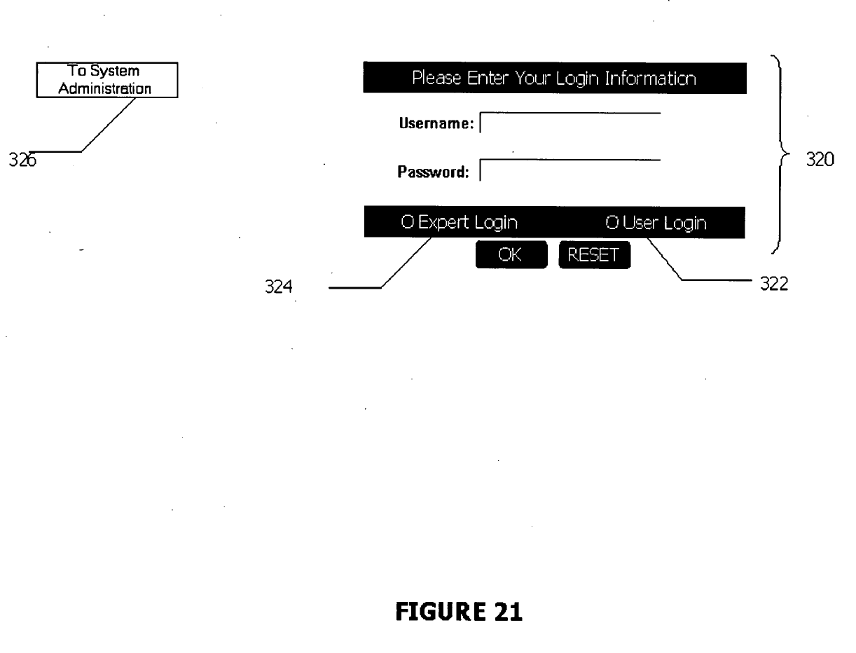

At this point the client may click on the “Done with Configuring Solution” button 318 to go to the main login screen of the solution 320 as illustrated in FIG. 21. The solution is now ready to be used by customers and client service representatives by logging into the solution with either the “User Login” radio button 322 or “Expert Login” radio button 324 enabled.

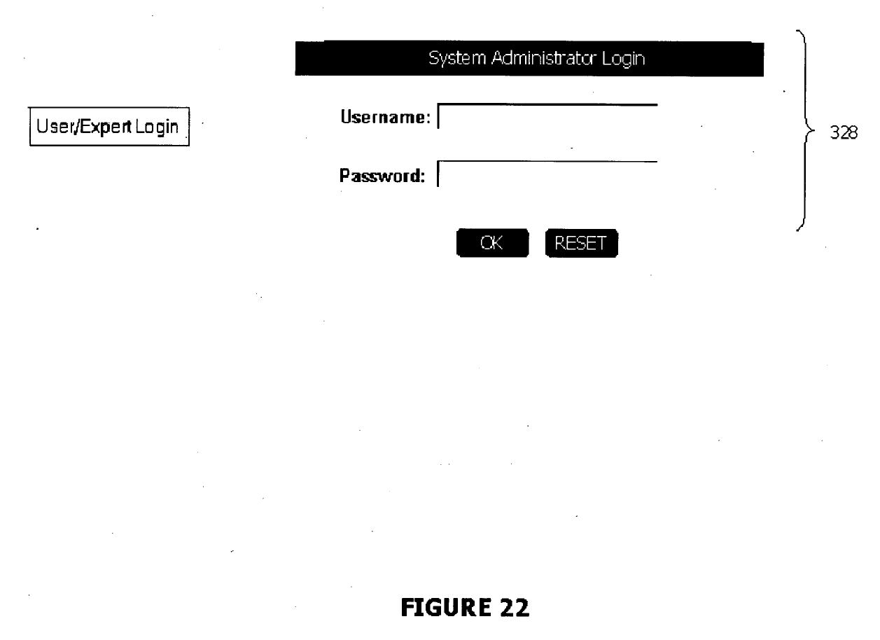

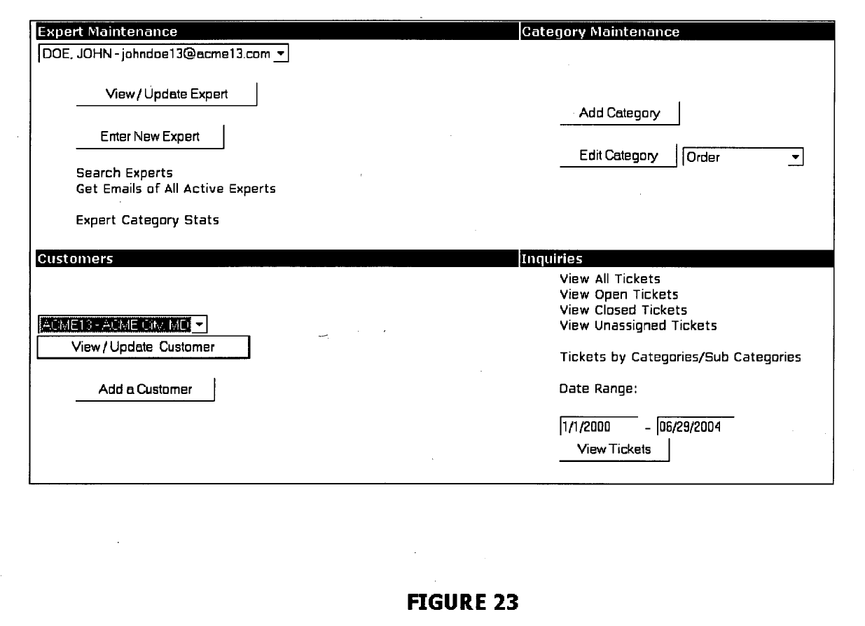

The “To System Administration” button 326 allows the client admin to navigate to login sheet 328 in FIG. 22 where the client admin can login to make further configuration or customizations and on-going maintenance to the business solution as illustrated in FIG. 23.

The system and method embodiments can also be used in a general way to customize and run other type of software solutions over a network in a variety of other areas not related to customer service. Thus the customer service application of the disclosed embodiments is not meant as a limitation, but is illustrative of the concept of clients being able to select from a wide variety of customer service business solutions and to customize the selected application to their specific environment via a network in a few simple steps.

It will therefore be apparent to those skilled in the art that other variations of embodiments for customizing all manner of software applications via a network and supporting those customizations with expert support can be achieved without departing from the scope of the invention as disclosed.

It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the,” is not to be construed as limiting the element to the singular.

What is claimed is:

1. A system for customizing software business solutions for a plurality of clients, comprising:
a network;
a vendor server connected to the network, the vendor server further connected to:
a client database comprising data for customizing a software business solution for a client;
a software business solution database for providing customer service business solutions to clients;
a client customer database comprising customer information for each customer of each client;
an expert database comprising customer service representative information for each client;
the vendor server further comprising:
instructions for storing and retrieving login information associated with a client customer in the client customer database;
instructions for serving a customized customer service business solution to the client customer over the network upon customer login, wherein the customer service business solution is customized based on an associated software business solution from the software business solution database, associated client information from the client database, and information at least one of a group selected from an associated client customer database and an associated expert database; and
instructions for allowing an administrator for a client to supply data to the client database, customer information to the client customer database, and information to the expert database over the network; and
at least one client customer computer connected to the network for logging into the server and accessing the customized software business solution.

2. The system for allowing customization of claim 1, wherein the vendor server further comprises computer-readable media embodying instructions for allowing the administrator for a client to add information about the client's organization to include the name and address of the organization in the client database.

3. The system for allowing customization of claim 1, wherein the vendor server further comprises computer-readable media embodying instructions for allowing the administrator for a client to select a customer service business solution from a list of software business solutions corresponding to the software business solution database.

4. The system for allowing customization of claim 1, wherein the vendor server further comprises computer-readable media embodying instructions for allowing the administrator for a client to add the client organization's logo to the corresponding client database.

5. The system for allowing customization of claim 1, wherein the vendor server further comprises computer-readable media embodying instructions for allowing the administrator for a client to customize a screen label name for data fields of the business solution.

6. The system for allowing customization of claim 1, wherein the vendor server further comprises computer-readable media embodying instructions for allowing the administrator for a client to customize text fields used by the business solution to generate communication messages.

7. The system for allowing customization of claim 1, wherein the vendor server further comprises a categories database and a subcategories database for storing data associated with each customized customer service business solution, which data is selected by the administrator for a client to customize the customer service business solution.

8. The system for allowing customization of claim 7, wherein the vendor server further comprises computer-readable media embodying instructions for displaying a summary of customizations that the administrator for a client has performed.

9. The system for allowing customization of claim 7, wherein the customer service business solution is customized based on associated data from the categories database and subcategories database to allow service inquiries to experts based upon a selected category and subcategory.

10. The system for allowing customization of claim 1, wherein the vendor server further comprises computer-readable media embodying instructions for allowing the administrator for a client to add customers to the client customer database and experts to the expert database and for assigning login and contact information for those customers and experts.

11. The system for allowing customization of claim 10, wherein the vendor server further comprises computer-readable media embodying instructions for allowing the administrator for a client to assign administrator privileges to one or more customers being added to the client customer database and/or experts being added to the expert database.

12. The system for allowing customization of claim 1, wherein the vendor server further comprises computer-readable media embodying instructions for allowing the administrator for a client to access a series of customization steps and have the system display a check mark next to each customization step when it is completed.

13. The system for allowing customization of claim 7, wherein the vendor server further comprises computer-readable media embodying instructions for allowing the administrator for a client to add service categories to a list resident in the categories database.

14. The system for allowing customization of claim 13, wherein the vendor server further comprises computer-readable media embodying instructions for allowing the administrator for a client to add service subcategories to a list resident in the subcategories database.

15. The system for allowing customization of claim 7, wherein the vendor server further comprises computer-readable media embodying instructions for allowing the administrator to add experts to a list resident on the experts database and for storing contact information, expertise level and a resume for each expert on the experts database.

16. The system for allowing customization of claim 15, wherein the vendor server further comprises computer-readable media embodying instructions for allowing the administrator for a client to assign to the expert appropriate categories of service from the categories database.

17. The system for allowing customization of claim 16, wherein the vendor server further comprises computer-readable media embodying instructions for allowing the administrator for a client to assign to the expert sub-categories of service from the subcategories database.

18. The system for allowing customization of claim 15, wherein the vendor server further comprises computer-readable media embodying instructions for allowing the administrator for a client to activate any of the experts and change any experts' availability or area of expertise.

19. The system for allowing customization of claim 9, wherein the vendor server further comprises computer-readable media embodying instructions for:
allowing a customer to log in, select a service category and subcategory, and submit an inquiry;
routing the inquiry to at least one expert; and
allowing the expert to close the inquiry upon communicating with the customer to resolve the inquiry.

20. The system for allowing customization of claim 19, wherein the vendor server further comprises computer-readable media embodying instructions for submitting the inquiry comprising:
supplying a text box for a customer to input an inquiry; and
supplying a communication method selection.

21. The system for allowing customization of claim 20, wherein the vendor server further comprises computer-readable media embodying instructions for routing the inquiry comprising:
allowing experts to book the inquiry;
assigning the inquiry to one or more experts based on workflow; and
notifying the expert of the customer's selected communication method.

22. The system for allowing customization of claim 19, wherein the vendor server further comprises computer-readable media embodying instructions for:
sending a survey to the customer after the inquiry is closed; and
rating the expert based upon survey results.

23. A method for customizing customer service business solution software over a network, comprising:
a vendor storing customer service business solution software on a database connected to a server;
the vendor collecting data for customizing the customer service business solution software for a client, customer information, and expert information from the client over the network;
storing the data for customizing customer service business solution software for the client on a database connected to the server;
storing the customer information on a database connected to the server;
storing expert information on a database connected to the server;
generating and storing login information associated with each customer on a database connected to the server; and
serving the customized customer service business solution from the server to a computer of the client's customer over the network upon customer login, wherein the customized customer service business solution is customized based on the associated data for customizing customer service business solution software, the associated customer information, and associated expert information.

24. The method of claim 23, wherein the data for customizing customer service business solution software comprises information selected from the group consisting of: name and address of the client organization, the client organization's logo, screen label names for data fields of the customer service business solution software, text fields used by the customer service business solution software to generate communication messages to customers, and combinations thereof.

25. The method of claim 23, wherein customer information is selected from the group consisting of: login information, contact information, and combinations thereof.

26. The method of claim 23, further comprising:
storing categories and subcategories of customer service inquiries selected by the client to customize the customer service business solution software for each client.

27. The method of claim 26, further comprising the server:
allowing a customer to log in, select a service category and subcategory, and submit an inquiry;
routing the inquiry to at least one expert; and
allowing the expert to close the inquiry upon communicating with the customer to resolve the inquiry;

28. The method of claim 26, wherein submitting the inquiry further comprises the server:
supplying a text box for a customer to input an inquiry; and
supplying a communication method selection.

29. The method of claim 26, wherein the routing of the inquiry further comprises the server:
allowing experts to book the inquiry;
assigning the inquiry to one or more experts based on workflow; and
notifying the expert of the customer's selected communication method.

30. The method of claim 26, further comprising the server:
sending a survey to the customer after the inquiry is closed; and
rating the expert based upon survey results.
